(19) United States
(12) Patent Application Publication
(10) Pub. No.: US 2024/0011936 A1
(43) Pub. Date: Jan. 11, 2024

(54) METAL DOPED ORGANIC FRAMEWORK-BASED CATALYST, AND OXYGEN SENSING ELECTRODE USING SAME

(71) Applicants: PUSAN NATIONAL UNIVERSITY INDUSTRY-UNIVERSITY COOPERATION FOUNDATION, Busan (KR); NF CO.,Ltd, Busan (KR)

(72) Inventors: Yoon-Bo SHIM, Busan (KR); Deog Su PARK, Busan (KR); Sang Kon LEE, Busan (KR); Jae Hoon LEE, Ulsan (KR); Sang Hoon KIM, Anyang-si (KR)

(73) Assignees: PUSAN NATIONAL UNIVERSITY INDUSTRY-UNIVERSITY COOPERATION FOUNDATION, Busan (KR); NF CO.,Ltd, Busan (KR)

(21) Appl. No.: 18/372,148

(22) Filed: Sep. 25, 2023

Related U.S. Application Data
(63) Continuation of application No. PCT/KR2022/003724, filed on Mar. 17, 2022.

(30) Foreign Application Priority Data
Mar. 30, 2021 (KR) 10-2021-0041099

(51) Int. Cl. G01N 27/407; B33Y 80/00; B33Y 70/10; G01N 27/30

(52) U.S. Cl. CPC G01N 27/4075; B33Y 80/00; B33Y 70/10; G01N 27/308

(57) ABSTRACT

The present invention relates to a metal doped organic framework-based catalyst, and an oxygen sensing electrode using same, wherein the 3D oxygen sensing electrode is manufactured easily and quickly at a low cost by using a trace amount of noble metal, by means of a polymer/graphene/nanocatalyst composition prepared by 3D printing and nanocatalyst synthesis on the basis of a metal doped organic framework and the 3D oxygen sensing electrode is capable of selectively sensing gases and dissolved oxygen and exhibits long-term stability.

### TECHNICAL FIELD

The present disclosure relates to a metal doped organic framework-based catalyst and an oxygen sensing electrode using the same.

### BACKGROUND ART

Oxygen sensors are electronic devices to measure partial pressure of oxygen in gases or liquids and are used in various fields such as medicine, physiology, biochemistry, food and drug production, environmental management and waste treatment, and corrosion prevention.

Oxygen measurement methods include gas chromatography, Winkler method, optical method, surface acoustic wave measurement, and electroanalysis, of which an electrochemical sensing method is widely used the most. Electrochemical sensing methods include cyclic voltammetry, linear sweep voltammetry, and chronoamperometry. These methods ensure high sensitivity, favorable selectivity and reproducibility, and easiness in miniaturization owing to stable and low power consumption.

Precious metals such as platinum and gold are used as electrode materials in most oxygen sensors, but their unit cost is high, such that it is necessary to develop new sensor catalyst materials with economic feasibility, high sensitivity, selectivity, and stability.

In general, precious metal (Pt, Au, Pd etc.) nanoparticles have been used as electrode catalyst materials for oxygen sensing in recent years, but they still have disadvantages such as high cost, poor stability, and overvoltage.

Therefore, there is a need for research on production of catalysts with low unit cost as well as outstanding selective catalytic reaction and stability using a trace amount of precious metals for oxygen sensing.

### DISCLOSURE OF THE INVENTION

### Technical Goals

An object of the present disclosure is to provide a catalyst for sensing oxygen with low unit cost using a trace amount of precious metals as well as excellent selective catalytic reaction and stability, and a preparation method thereof.

In addition, another object of the present disclosure is to provide a composition for 3D printing containing the catalyst and an oxygen sensing electrode that is 3D printed using the same.

### Technical Solutions

In order to achieve the above objective, the present disclosure provides a metal doped organic framework-based catalyst which includes a metal salt; and a nitrogen-doped carbon framework, wherein the metal salt is bound to a nitrogen-doped carbon frame work.

In addition, the present disclosure provides a composition for 3D printing which includes a polymer; carbon; and the metal doped organic framework-based catalyst.

In addition, the present disclosure provides a 3D printed oxygen sensing electrode using the composition for 3D printing.

In addition, the present disclosure provides a method of preparing a metal doped organic framework-based catalyst, including preparing a carbon precursor by adding an aldehyde solution to a compound solution containing nitrogen and performing hydrothermal synthesis; calcining the carbon precursor under nitrogen conditions to prepare a nitrogen-doped carbon framework (NC); and reacting a solution containing the NC with a metal solution using a microwave.

### Advantageous Effects

In the present disclosure, by metal doped organic framework based nanocatalyst synthesis and a polymer/graphite/nanocatalyst composition with 3D printing applied, a 3D oxygen sensing electrode was prepared in an easy and fast way with low cost using a trace amount of precious metal, and the 3D oxygen sensing electrode is capable of selectively sensing gas and dissolved oxygen with an ability to sense oxygen present in medicine, environment, and other fields over a wide range of concentrations, such that it may be very useful for on-site analysis and stably sense oxygen for a long time.

### BRIEF DESCRIPTION OF DRAWINGS

FIG. 1 shows a representative schematic diagram of nanocatalyst synthesis according to an example embodiment of the present disclosure.

FIG. 2 shows a representative schematic diagram of production of a 3D printed electrode (3D-P/G/NC) and oxygen sensing in gas according to an example embodiment of the present disclosure.

FIG. 3 shows a diagram illustrating a nanocatalyst image according to Example 1.

FIG. 4 shows a diagram illustrating XPS measurement results of a nanocatalyst according to Example 1.

FIG. 5 shows a diagram illustrating a surface image of a 3D-P/G/NC electrode according to Example 2.

FIG. 6 shows diagrams to identify a surface charge of a 3D-P/G/NC electrode according to Example 2.

FIG. 7 shows diagrams illustrating a potential window for dissolved oxygen sensing of a 3D-P/G/NC electrode, a signal change by concentration, and a calibration curve for sensing corresponding thereto according to Experimental Example 1.

FIG. 8 shows diagrams illustrating a signal change by concentration for oxygen in gas with a 3D-P/G/NC electrode and a calibration curve for sensing corresponding thereto according to Experimental Example 1.

FIG. 9 shows diagrams to check a hysteresis for oxygen sensing in gas with a 3D-P/G/NC electrode according to Experimental Example 1.

FIG. 10 shows diagrams illustrating long-term stability upon oxygen sensing of a 3D-P/G/NC electrode according to Experimental Example 1.

### BEST MODE FOR CARRYING OUT THE INVENTION

Hereinafter, the present disclosure will be described in detail.

The present disclosure was completed by preparing, by metal doped organic framework based nanocatalyst synthesis and a polymer/graphite/nanocatalyst composition with 3D printing applied, a 3D oxygen sensing electrode in an easy and fast way with low cost using a trace amount of precious metal, and discovering that the 3D oxygen sensing electrode is capable of selectively sensing gas and dissolved oxygen and has excellent stability to sense oxygen present in medicine, environment, and other fields over a wide range of concentrations, such that it may be very useful for on-site analysis.

The present disclosure provides a metal doped organic framework-based catalyst which includes a metal salt; and a nitrogen-doped carbon framework, wherein the metal salt is bound to a nitrogen-doped carbon frame work.

In this case, the catalyst is a spherical nanoparticle with an average diameter of 300 to 500 nm, and the metal is one or more types selected from the group consisting of Pt, Au, Pd, Ru, Rh, Ir, Co, and Fe, preferably platinum (Pt).

In addition, the catalyst is used for oxygen sensing, and specifically, it is capable of selectively sensing gas and dissolved oxygen.

In addition, the present disclosure provides a composition for 3D printing which includes a polymer; carbon; and the metal doped organic framework-based catalyst.

In this case, the polymer is one or more types selected from the group consisting of acrylonitrile butadiene styrene (ABS), high impact polystyrene (HIP), and nylon, preferably high impact polystyrene (HIP), but is not limited thereto.

In addition, the carbon is one or more types selected from the group consisting of carbon nanotubes, graphene oxide, reduced graphene oxide, and graphite, preferably graphite, but is not limited thereto.

In addition, the present disclosure provides an oxygen sensing electrode that is 3D printed using the composition for 3D printing.

According to an example embodiment of the present disclosure, it was found that the 3D printed oxygen sensing electrode is capable of selectively sensing gas and dissolved oxygen and has excellent long-term stability.

In addition, the present disclosure provides a method of preparing a metal doped organic framework-based catalyst, including preparing a carbon precursor by adding an aldehyde solution to a compound solution containing nitrogen and performing hydrothermal synthesis; calcining the carbon precursor under nitrogen conditions to prepare a nitrogen-doped carbon framework (NC); and reacting a solution containing the NC with a metal solution using a microwave.

In this case, the compound containing nitrogen is one or more types selected from the group consisting of ethylenediamine, 3-aminophenol, and hexamethylenediamine, preferably 3-aminophenol, but is not limited thereto.

In addition, the aldehyde is one or more types selected from the group consisting of acetaldehyde, formaldehyde, propionaldehyde, and n-butyraldehyde, preferably formaldehyde, but is not limited thereto.

In addition, the hydrothermal synthesis is performed by a reaction at 50 to 250° C. for 12 to 72 hours, preferably at 100° C. for 24 hours, but is not limited thereto.

In addition, the calcination is performed by a reaction at 500 to 1000° C. for 1 to 5 hours, preferably at 900° C. for 4 hours, but is not limited thereto.

In addition, the metal is one or more types selected from the group consisting of Pt, Au, Pd, Ru, Rh, Ir, Co, and Fe, preferably platinum (Pt), but is not limited thereto.

In addition, the microwave reaction is performed by a reaction at 300 to 1000 W for 30 seconds to 5 minutes, preferably at 500 W for 2 minutes, but is not limited thereto.

Deviation from the conditions in the method of preparing the metal doped organic framework-based catalyst as described above may lead to improper formation of the metal doped organic framework-based nanocatalyst according to the present disclosure, causing an issue that it may not be applicable as a catalyst for the oxygen sensing electrode due to a lack of effects in terms of selective sensing of gas and dissolved oxygen and long-term stability as the oxygen sensing electrode.

According to an example embodiment of the present disclosure, when 3-aminophenol and formaldehyde undergo a hydrothermal reaction, a polymerization reaction occurs with formaldehyde at positions 2, 4, and 6 of 3-aminophenol to form a carbon precursor. When the resulting carbon precursor is calcined under the nitrogen condition, H₂ drops and N doped C is synthesized.

Thereafter, when N doped C and HₓMCl_{y} are mixed together, C becomes relatively positively (+) charged as N in N doped C attracts electrons of C next to it so as to be in a state in which MCl_{y}^{x-} is readily bonded to the positively charged C, and at this time, if a microwave is applied, the metal and C adjacent to N undergo a chemical reaction, resulting in the synthesis of a very stable nanocatalyst.

In the present disclosure, a carbon composite in which a trace amount of metal catalyst particles and heteroatoms (N or S atoms) are included is synthesized to synthesize a catalyst with high sensitivity. According to the present disclosure, synthesized hetero atom composite nanocatalysts with a lower content of catalyst metals may cause selective catalysis reactions and provide a new oxygen reduction catalyst material that is very stable and inexpensive compared to single metal catalysts. By mixing the finally synthesized MOF-based nanocatalyst along with a 3D printing polymer material and graphite and then undergoing printing, a sensor in which an oxygen sensing electrode material is used was developed, ensuring low cost as well as high stability and sensitivity.

### MODES FOR CARRYING OUT THE INVENTION

Hereinafter, the present disclosure will be described in more detail through example embodiments. These example embodiments are only for the purpose of describing the present disclosure in more detail, and it will be apparent to those of ordinary skill in the art to which the present disclosure pertains that the scope of the present disclosure is not limited by these example embodiments according to the gist of the present disclosure.

### <Example 1> Synthesis of an MOF-Based Nanocatalyst

1. Synthesis of a Nitrogen-Doped Carbon Framework

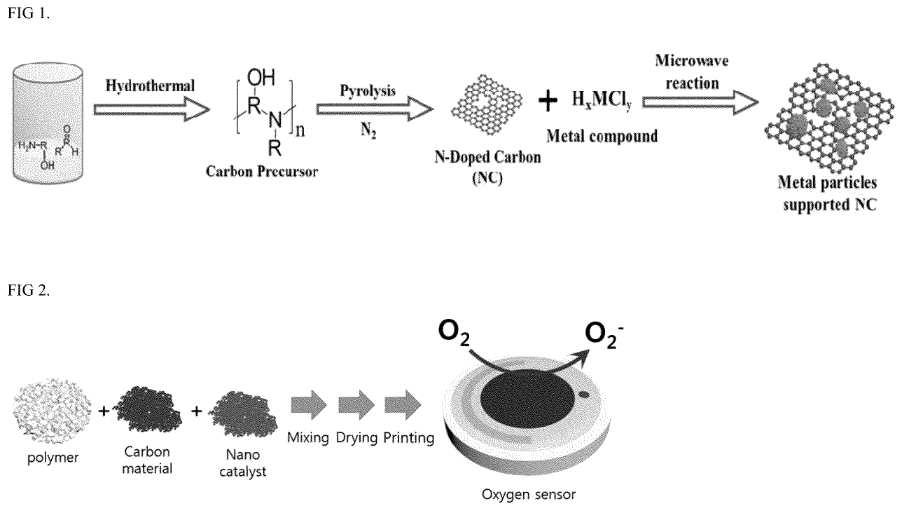

1.4 g of 3-aminophenol and 0.20 mL of ammonia initiator were added to 40 mL of ethanol solvent, and the mixture was stirred at 25° C. for 24 hours. Here, 1 mL of formaldehyde solution was slowly added for 1 hour, and then a reaction was carried out at 100° C. for 24 hours to prepare a carbon precursor. Subsequently, using a washing solution (water, ethanol) under a condition of 20000 RPM for 4 minutes, centrifugation was performed twice each, followed by drying. Then, a nitrogen-doped carbon framework was prepared by calcination under nitrogen conditions at 900° C. for 4 hours (FIG. 1).

2. Synthesis of a Nitrogen-Doped Carbon Framework Bound with Precious Metal

50 mL of ethylene glycol solvent was added to 50 mg of the nitrogen-doped carbon framework synthesized above, followed by stirring for 1 hour. 1 mL of 0.20 M potassium hydroxide solution was slowly added to the mixture with stirring for 0.5 hours, followed by stirring for 0.5 hours. Thereafter, 1 mL of 0.02 M H₂PtCl₄ metal solution was slowly added and stirred for 1 hour. Then, a reaction was carried out in a 500 W microwave reactor for 2 minutes, centrifugation was performed three times each using a washing solution (water, acetone) at 20000 RPM for 30 minutes, and then drying was followed to prepare a nitrogen-doped carbon framework bound with precious metals (FIG. 1).

3. Analysis of the Synthesized Nitrogen-Doped Carbon Framework Bound with Precious Metal

The characteristics of nitrogen-doped carbon framework nanocatalysts bound with precious metals synthesized by the preparation methods as above and Examples 1-1 and 1-2 were identified using SEM and XPS.

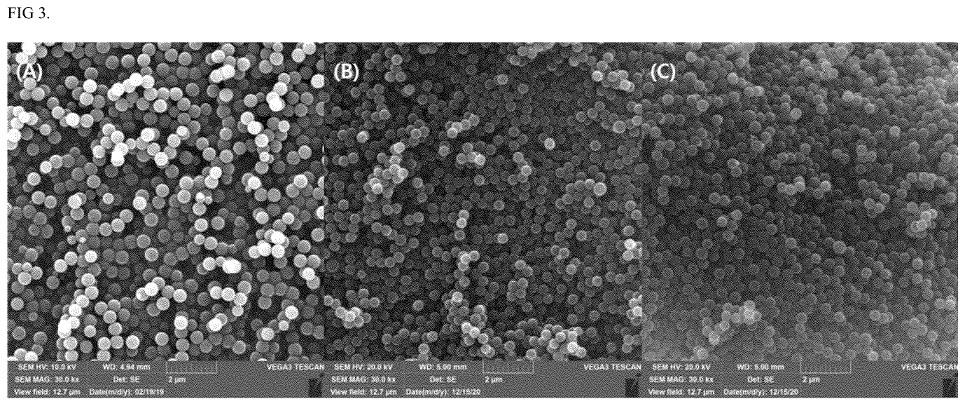

FIG. 3 is a result of observing a synthesis process of the nanocatalyst with a field emission scanning electron microscope (hereinafter referred to as ‘SEM’).

(A) represents a carbon precursor before calcination, (B) represents an N doped C framework after calcination, and (C) represents an N doped C framework containing metal. Before calcination, particles in an average of 500 nm were formed, but after calcination, it was observed that the particles had size reduction to about 380 nm. In addition, it was observed, in the nanocatalyst containing the metal, that the nanoparticles were synthesized in the same size as the N-doped C framework.

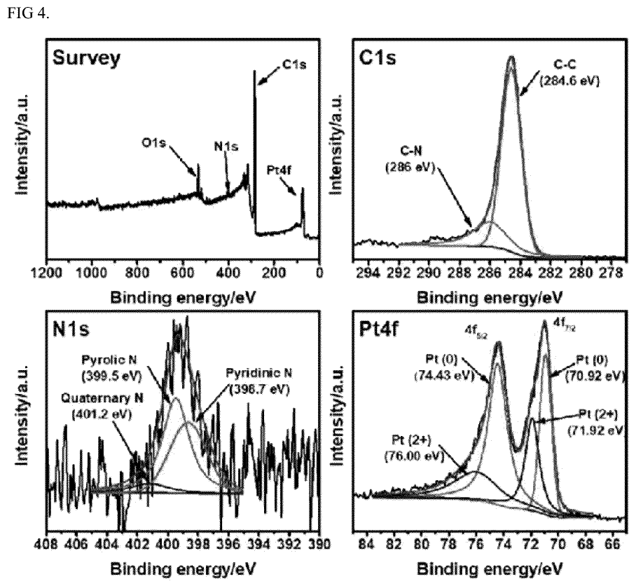

FIG. 4 shows results of observation with XPS of synthesized nanocatalysts.

C—C(284.6 eV) and C—N(286 eV) bonds of N doped carbon were observed in the C1s, and pyridinic bonds (398.7 eV), pyrrolic bonds (399.5 eV), and quaternary bonds (401.2 eV) of N doped C were observed in the Nis. In addition, by adding Pt to N doped C, Pt(0) (70.92 eV and 74.43 eV) and Pt (2+) (71.92 eV and 76.00 eV) were observed in pairs at 4f_{5/2} and 4f_{π/2}, respectively.

Therefore, it was found that the nanocatalyst prepared through Example 1 had a spherical structure formed as Pt is bonded to the nitrogen-doped carbon framework.

### <Example 2> Production of a 3D Printed Oxygen Sensing Electrode (3D-P/G/NC)

1. Production of a 3D Printing Filament with Nanocatalysts Included

10 g of high impact polystyrene (HIPs)(P), a polymer for 3D printing, was dissolved in 0.1 L of dichloromethane solvent. 6.6 g of graphite (C) and 0.10 g of nanocatalyst material (NC) were added to 0.05 L of dichloromethane solvent and dispersed using sonic treatment for 2 hours.

Thereafter, a solution in which the graphite and nanocatalyst material are dispersed was added to the solvent containing the HIPs, and the mixture was dried with stirring for 24 hours. Then, after crushing the dried product, the filament was extruded under conditions of 220° C. and 30 cm/min using a filament extruder (FIG. 2).

2. Production of an Oxygen Sensing Electrode

The filament of Example 2-1 was 3D printed using a 3D printer at 240° C. under mm/s heating bed condition at 90° C. (3D-P/G/NC). Thereafter, the electrode printed on the electrode body and the Pt and Ag wires were connected, and Ag/AgCl was coated onto a surface of Ag.

To make a solid electrolyte, 0.1 g of silicone rubber adhesive and 1 g of electrolyte tetrabutylammonium perchlorate were dissolved in 10 mL of hexane solvent.

Thereafter, 0.01 mL of the solid electrolyte solution was spin coated at 3000 RPM on the surface of the printing electrode to which the Pt and Ag were connected, and the 3D printed oxygen sensing electrode (3D-P/G/NC) was prepared (FIG. 2).

3. Analysis of the Produced Oxygen Sensing Electrode

The characteristics of the electrode produced by the preparation methods in Examples 2-1 and 2-2 were identified using SEM.

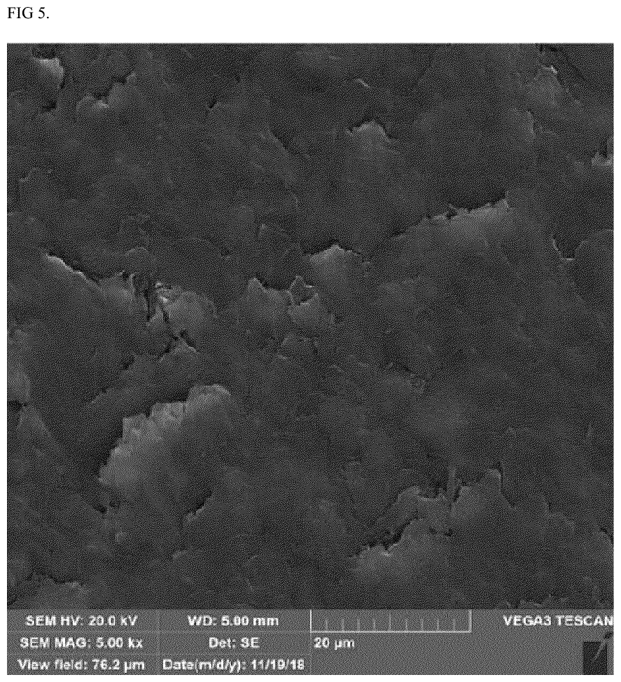

FIG. 5 shows a result of observing the 3D printed oxygen sensing electrode (3D-P/G/NC) by SEM, and it was found that the electrode surface was evenly mixed and printed.

### <Experimental Example 1> Performance Evaluation of the Sensor

1. Cyclic Voltammetry (CV), Linear Sweep Voltammetry (LSV), and Chronoamperometry (CA) Analysis

Linear sweep voltammetry (hereinafter referred to as ‘LSV’) and chronoamperometry (hereinafter referred to as ‘CA’) were measured using a potentiostat/galvanostat (Kosentech Model KST-P2, Korea).

In this case, a 3-electrode system was used, in which the 3D-P/G/NC (diameter: 1.75 mm) prepared by Example 2 above, Ag/AgCl, and platinum wires were used as a working electrode, a reference electrode, and a counter electrode, respectively.

CV analysis was measured by scanning a reduction potential at 0.2 to −0.9 V compared to Ag/AgCl and then scanning an oxidation potential at −0.9 to 0.2 V. In this case, the scanning rate was 50 mV/s.

LSV analysis was measured by scanning a reduction potential at −0.2 to −1.1 V compared to Ag/AgCl. In this case, the scanning rate was 50 mV/s.

The CA analysis was scanned for 10 seconds at a reduction potential at −0.9 V.

2. Preparation for Measurement of Dissolved Oxygen and Oxygen Gas

A 0.1 M PBS (pH 7.4) buffer solution was prepared to measure dissolved oxygen, and then a 3D-P/G/NC electrode was transferred to a electrochemical cell containing a 0.1 M PBS buffer solution. Nitrogen gas was aerated in the buffer solution for 20 minutes to remove the dissolved oxygen, and the temperature of the solution was adjusted to 25° C. The analysis was performed by changing the oxygen aeration time and adjusting a concentration of the dissolved oxygen.

In the case of gaseous oxygen measurement, a sensor with an electrolyte placed on an oxygen sensing electrode containing 3D-P/G/NC was inserted into a tube through which nitrogen and oxygen pass, and analysis was performed while changing the concentration of oxygen.

3. Identification of Characteristics of the Electrode

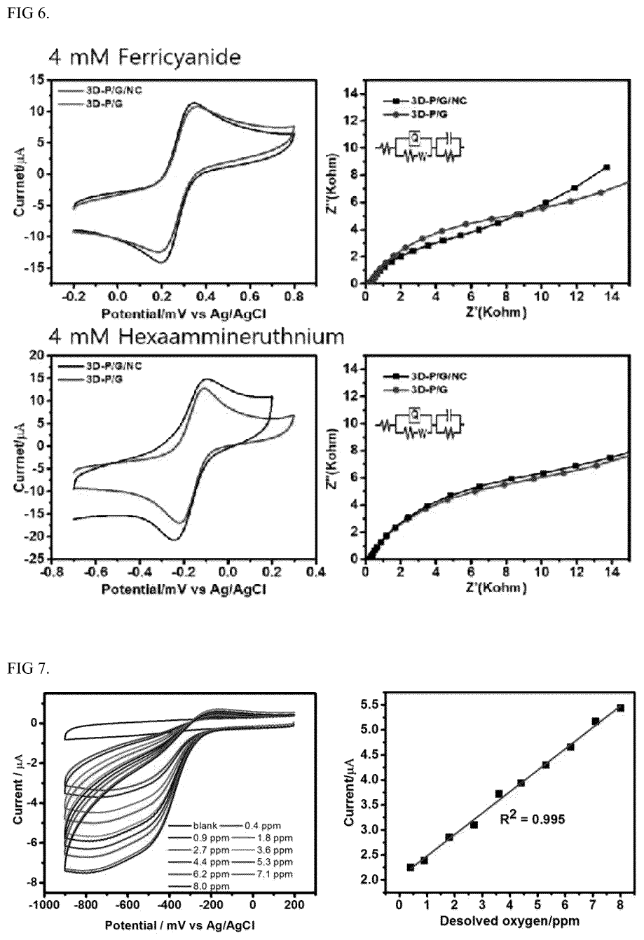

FIG. 6 shows a diagram illustrating a potential window of 3D-P/G/NC and 3D P/G without nanocatalyst in 4 mM ferricyanide solution and 4 mM hexaammineruthenium using cyclic voltammetry (CV) and electrochemical impedance spectroscopy (EIS) in order to check a polarity of an electrode surface before and after adding the nanocatalyst.

In the comparison of the CV results, when measured in 4 mM ferricyanide solution, the plotted peak current values of 3D-P/G/NC and 3D-P/G were 12.24 μA and 10.68 μA, respectively, indicating that 3D-P/G/NC with the nanocatalyst added showed a peak current value that is 1.14 times greater. For 4 mM hexaammineruthenium, the peak current values of 3D-P/G/NC and 3D-P/G were 12.05 μA and 14.15 μA, respectively, indicating that 3D-P/G without nanocatalysts added showed a peak current value that is 1.17 times greater.

In addition, when the EIS results were compared, when measured in 4 mM ferricyanide solution, the 3D-P/G/NC and 3D-P/G RCT values were 3.33 kΩ and 10.2 kΩ, respectively, indicating that the 3D-P/G/NC without nanocatalyst added showed a resistance value that is 3 times lower, and for 4 mM hexaammineruthenium, the peak RCT values of 3D-P/G/NC and 3D-P/G were 14.3 kΩ and 13.4 kΩ, respectively, indicating that 3D-P/G without nanocatalyst added showed a resistance value that is 0.93 times lower. When comparing the above results, it was found that the electrode surface was positively (+) charged compared to before the catalyst was added due to the precious metal Pt and N doped C contained in the catalyst, securing suitability for sensing oxygen.

4. Identification of Dissolved Oxygen Sensing Calibration Curve and Sensing Limits

As shown in FIG. 7, an oxygen calibration curve was obtained using CV at the previously selected 200 to −900 mV potential. The sensing experiment was performed while the concentration of dissolved oxygen was increased from 0% (blank) to 100% (8.0 ppm). The current shown at −480 mV was expressed as a calibration curve, the correlation coefficient of the calibration curve was 0.995, and the dynamic range of the calibration curve was from 0% to 100%.

5. Identification of Gaseous Oxygen Sensing Calibration Curves and Sensing Limits

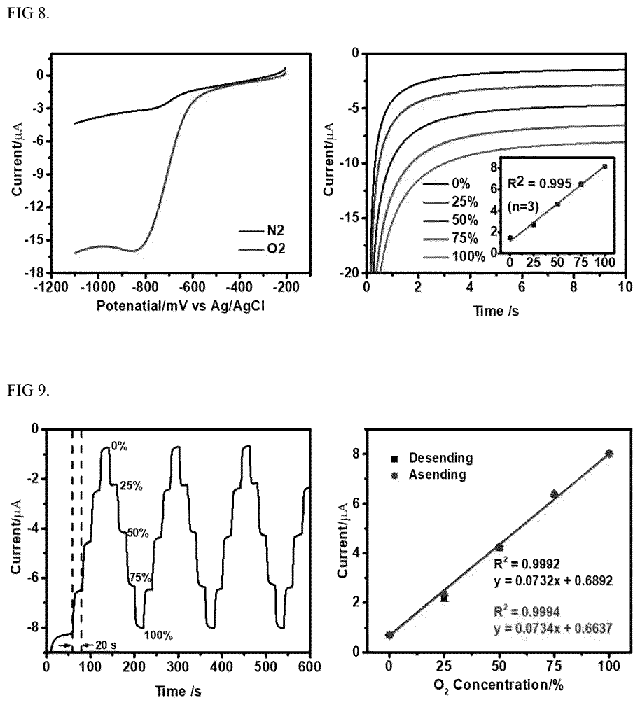

As shown in FIG. 8, the potential for sensing gaseous oxygen was obtained by measuring LSV through sufficient aeration of oxygen in the tube, and CA was used for measurement to identify the sensing calibration and sensing limits.

When LSV was checked, since oxygen was sensed at around −850 mV after aeration of gaseous oxygen, CA was measured in the voltage range of −900 mV. The sensing experiment was performed by increasing the concentration from 0% to 100%, the current shown at 10 seconds was expressed as a calibration curve, a correlation coefficient of the calibration curve was 0.995, and the dynamic range of the calibration curve was from 0% to 100%. The sensing limit calculated using a slope of the calibration curve was found to be 0.6%.

FIG. 9 shows a phenomenon of hysteresis of a sensor when measuring the concentration of gaseous oxygen. It was measured using CA at a reduction potential at −900 mV, and measurement was performed by changing the oxygen concentration at intervals of 20 seconds.

The correlation coefficients of the calibration curve when the oxygen concentration was decreased and increased were 0.999 and 0.999, respectively, and the linear equation obtained when the oxygen concentration was changed according to the calibration curve was y=0.0732x+0.6892 and y=0.0734x+0.6637, respectively, whose results were identical. In conclusion, stable sensitivity and reproducible results without the hysteresis phenomenon according to the concentration of the produced sensor were observed.

6. Identification of Long-Term Stability of the Oxygen Sensor

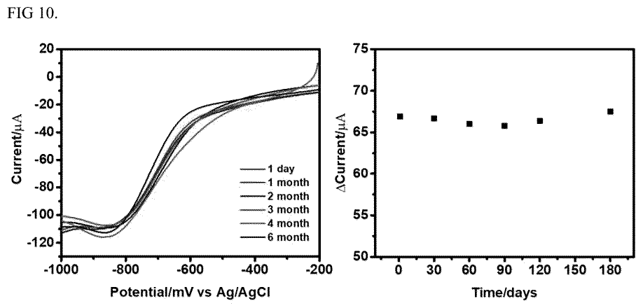

As shown in FIG. 10, gaseous oxygen was measured in the long term using LSV. In this case, a flow rate of oxygen was 4 LPM (liter per minute), and the ventilation time was seconds.

Peak current detected at around −850 mV was checked over time, and approximately 1% difference was observed when monitored up to 6 months. Therefore, it was determined that it could be measured for at least 6 months.

As described above, although the present disclosure has been described by limited example embodiments and drawings, the present disclosure is not limited thereby, and it is obvious that various modification and variations are possible within the equal range of the technical ideas of the present disclosure and the claims to be described below by a person skilled in the art to which the present disclosure pertains.

1. A metal doped organic framework-based catalyst, comprising:
a metal salt; and
a nitrogen-doped carbon framework,
wherein the metal salt is bound to a carbon atom of the framework,
wherein the catalyst is a spherical nanoparticle with an average diameter of 300 to 500 nm,
wherein the metal is one or more types selected from the group consisting of Pt, Au, and Pd, and
wherein the catalyst is used for oxygen sensing.

2. A composition for 3D printing, comprising:
a polymer;
carbon; and
the metal doped organic framework-based catalyst according to claim 1.

3. The composition for 3D printing of claim 2, wherein the polymer is one or more types selected from the group consisting of acrylonitrile butadiene styrene (ABS), high impact polystyrene (HIP), and nylon.

4. The composition for 3D printing of claim 2, wherein the carbon is one or more types selected from the group consisting of carbon nanotubes, graphene oxide, reduced graphene oxide, and graphite.

5. An oxygen sensing electrode that is 3D printed using the composition for 3D printing according to claim 2.

6. A method of preparing a metal doped organic framework-based catalyst, the method comprising:
preparing a carbon precursor by adding an aldehyde solution to a compound solution containing nitrogen and performing hydrothermal synthesis;
calcining the carbon precursor under nitrogen conditions to prepare a nitrogen-doped carbon framework (NC); and
reacting a solution containing the NC with a metal solution using a microwave.

7. The method of claim 6, wherein the compound containing nitrogen is one or more types selected from the group consisting of ethylenediamine, 3-aminophenol, and hexamethylenediamine.

8. The method of claim 6, wherein the aldehyde is one or more types selected from the group consisting of acetaldehyde, formaldehyde, propionaldehyde, and n-butyraldehyde.

9. The method of claim 6, wherein the hydrothermal synthesis is performed by a reaction at 50 to 250° C. for 12 to 72 hours.

10. The method of claim 6, wherein the calcination is performed by a reaction at 500 to 1000° C. for 1 to 5 hours.

11. The method of claim 6, wherein the metal is one or more types selected from the group consisting of Pt, Au, and Pd.

12. The method of claim 6, wherein the microwave reaction is performed at 300 to 1000 W for 30 seconds to 5 minutes.
